(19) United States
(12) Patent Application Publication
(10) Pub. No.: US 2021/0386230 A1
(43) Pub. Date: Dec. 16, 2021

(54) Insulated self-righting cup holder

(71) Applicant: Ludwig P. Vollers, III, Bellevue, WA (US)

(72) Inventor: Ludwig P. Vollers, III, Bellevue, WA (US)

(21) Appl. No.: 16/902,039

(22) Filed: Jun. 15, 2020

(51) Int. Cl. A47G 23/02; F16M 11/12

(52) U.S. Cl. CPC A47G 23/0216; A47G 2023/0275; F16M 2200/041; F16M 11/123

(57) ABSTRACT

The invention is an insulated self-righting cup holder. It is not simply just a gyroscopic cup holder. This is a new application of the concept of using a gyroscope to hold an open beverage using a self-contained, insulated container formed by a fabric cover mounted to a wide, stable, non-slip base. The invention does not require physical mounting or connection to a fixed object or surface. It can be placed on any surface inclined up to fifteen degrees from the horizontal. A full sixteen-ounce open beverage can be held by the invention while the invention is sitting on that surface without fear that it will topple over and spill the beverage . . . making it ideal for camping or other outdoor activities. The fabric cover can be printed with any design. The invention is lightweight, portable, and reusable.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

All documents related to this paten application (including this specification) have been submitted electronically in PDF format via EFS-Web. No documents have been submitted via compact disc and none are text files.

### STATEMENT REGARDING PRIOR DISCLOSURES BY THE INVENTOR OR A JOINT INVENTOR

There is a record of all prior documents submitted as part of the patent application in the PAIR Image File Wrapper. Any revisions to these documents have been made at the request of the USPTO.

### BACKGROUND OF THE INVENTION

Field of the Invention. Class D-7: Equipment for Preparing or Serving Food or Drink not Elsewhere Specified and/or A47G23/0225: Glass or bottle holders for drinking-glasses, plastic cups, or the like for one glass or cup attachable to a plate, table, or the like.

Description of the Related Art including information disclosed under 37 CFR 1.97 and 37 CFR 1.98. Patent US 2016/0081505 A1 Gyroscopic Cup Holder has similar elements, including the assembly of the gyroscope element: “Some embodiments of the present disclosure include a gimbaled beverage container holder configured to attach to an external object, such as luggage handles or other transport device. The holder may include an outer ring, middle ring, and removable inner ring and may use a center of gravity two axes gimbal to stabilize a beverage in the container in a reduced spill, near vertical position. The beverage container may be accommodated within the removable inner ring, providing two axes, or the larger middle ring, providing one axis, wherein each ring may rotate independently. The outer ring may include at least one attachment device. Such as an outer ring arm and/or an outer ring clip, to which may provide interchangeable attachments to most external objects or transport devices.” The art for this patent is clearly identifying the need for the invention to be attached to an external object. The drawing clearly shows the invention attached to the handle of a roller board suitcase. There is no insulating element, nor provision for the cup holder to be free-standing without attachment to an external object. The problem solved by the invention referenced in this application is the ability for the gyroscopic cup holder to be both insulating and free-standing on a variety of level and inclined surfaces with no attachment to an external object either being required or desired while still “stabilizing a beverage in the container in a reduced spill, near vertical position”.

### BRIEF SUMMARY OF THE INVENTION

The invention solves the problems associated with previously invented gyroscopic cup holders which is the requirement for them to be attached to an external object in order to function as invented and the lack of insulation to keep the held beverage at close to its preferred temperature (see above Background of the Invention 0008). This invention solves that problem by incorporating the gyroscopic cup holder into a self-contained, free-standing, insulated enclosure. The enclosure allows the cup holder to rest on a variety of level and inclined surfaces with no attachment to an external object either being required or desired while still “stabilizing a beverage in the container in a reduced spill, near vertical position”. The cup holder enclosure solves these problems by a) attaching a gyroscopic cup holder to the enclosure base, b) incorporating insulating foam beads that surround the cup holder, and c) incorporating a wide, non-slip, weighted base.

The benefit of the gyroscopic cup holder is that it keeps the cup in an upright position regardless of the incline of the surface the invention is placed on. There is a limit to the amount of incline slope that can be used. The invention is designed to work on inclines from zero to fifteen degrees from the horizontal as shown on drawings FIG. 2. Section View (level) and FIG. 4 Section View (inclined).

The benefit of using foam beads to insulate the cup holder is that the beads can move and adjust to the change in incline angle without hindering the benefits of the gyroscopic cup holder. The exterior of the invention enclosure is a fabric cover that contains the foam beads and allows for printed images.

The benefit of the wide, non-slip, weighted base is that it keeps the invention from toppling over sideways. The base consists of a round, textured, non-slip rubber and weighted beads separated from the foam insulating beads. The invention fabric cover has an “accordion” fold at the rubber base to allow the cover to expand when the invention is placed on an inclined surface.

### BRIEF DESCRIPTION OF THE SEVERAL VIEWS OF THE DRAWINGS

FIG. 1 Plan View. This drawing shows the invention from directly above. The round shape and 8″ diameter are indicated as are the fabric cover (1.01), the flexible, tubular collar (1.02), and the gyroscopic cup holder (1.03). The section view cut line (1.04) is also indicated.

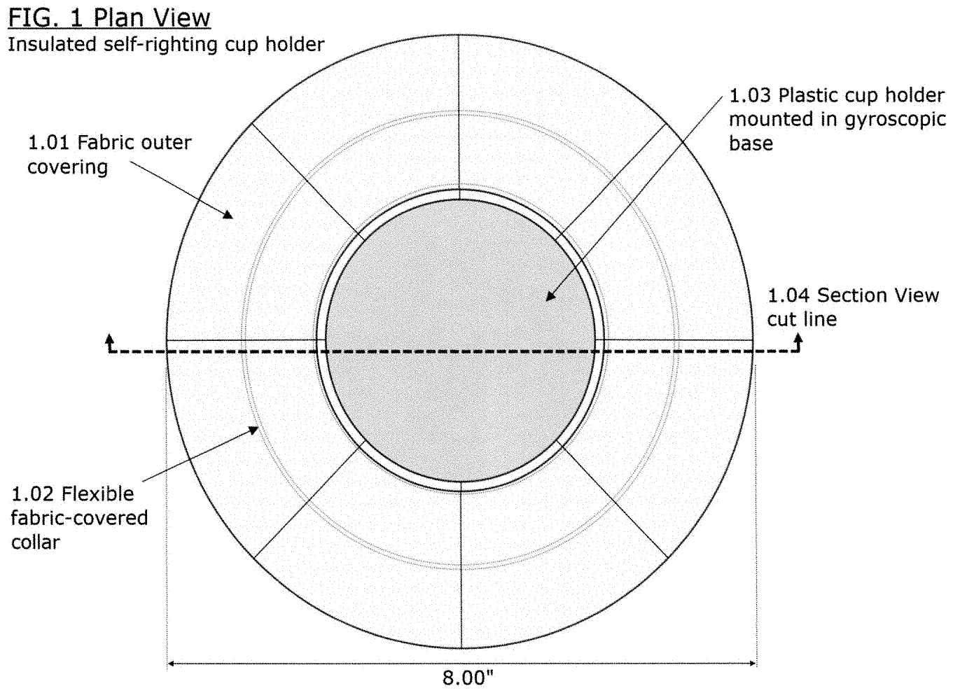

FIG. 2 Section View (level). This drawing shows the inside of the invention resting on a level surface. The 6″ height of the invention is indicated. Also shown are the insulating beads (2.01), the weighted beads (2.02), the accordion fold of the fabric cover (2.03) at the base, the gyroscope bracket attached to the base (2.04), the non-slip, rubber base (2.05), the bead separator membrane (2.06), the gyroscope outer ring (2.07), and a typical beverage cup not included with the invention (2.08). The fabric cover (1.01) wraps over the top of the flexible, tubular collar (1.02) and attaches between the collar (1.02) and the gyroscopic cup holder (1.03). The gyroscopic cup holder (1.03) consists of a gyroscope assembly which includes a middle ring connected to the cup holder at two rotational points and an outer ring (2.07) connected to the middle ring at two rotational points (offset by 90 degrees from the inside connection points) and two fixed points to the gyroscope mounting bracket (2.04).

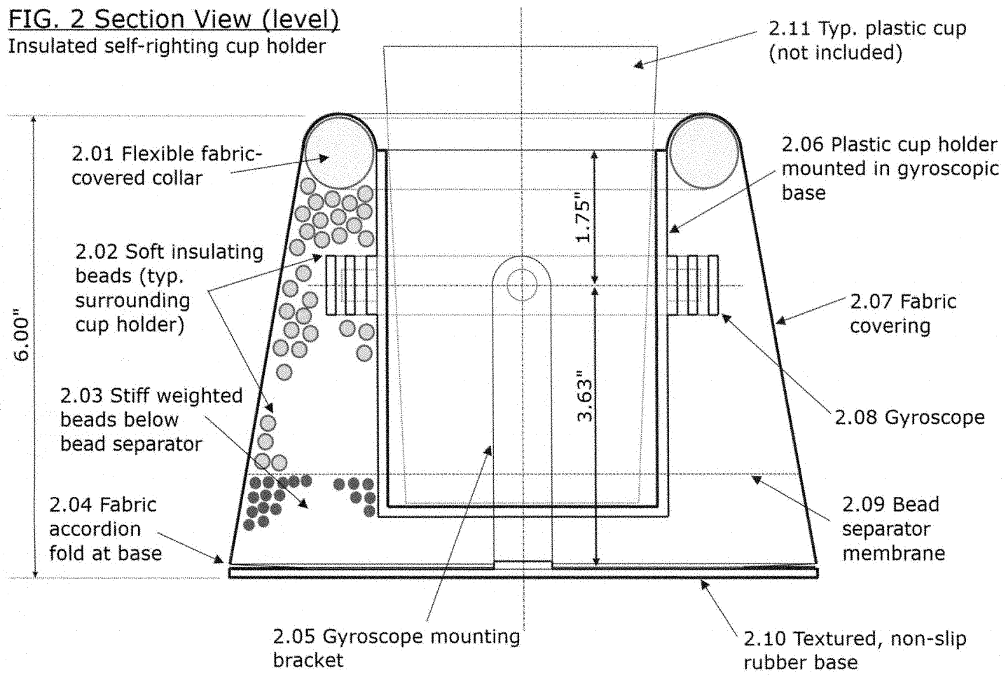

FIG. 3 Elevation View. This drawing shows the invention from the side, outside the invention. The key elements of FIG. 1 and FIG. 2 are indicated.

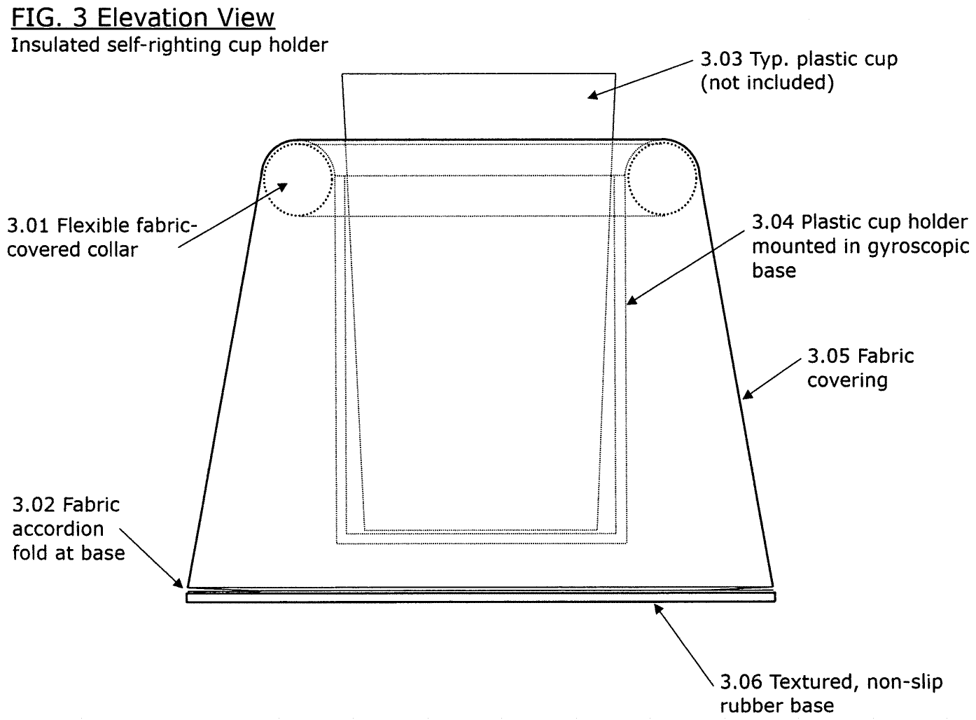

FIG. 4 Section View (inclined). This drawing shows the inside of the invention while resting on an inclined surface (4.01) of 15 degrees. The outer ring of the gyroscope (2.07) is fixed to the angle of the base and the perpendicular gyroscope bracket (2.04). The gyroscopic cup holder (1.03) remains vertical using one or both of the gyroscope axes. The accordion fold of the fabric cover (2.03) is shown to expand where needed to accommodate the incline of the enclosure. Other elements of FIG. 1 and FIG. 2 are also shown.

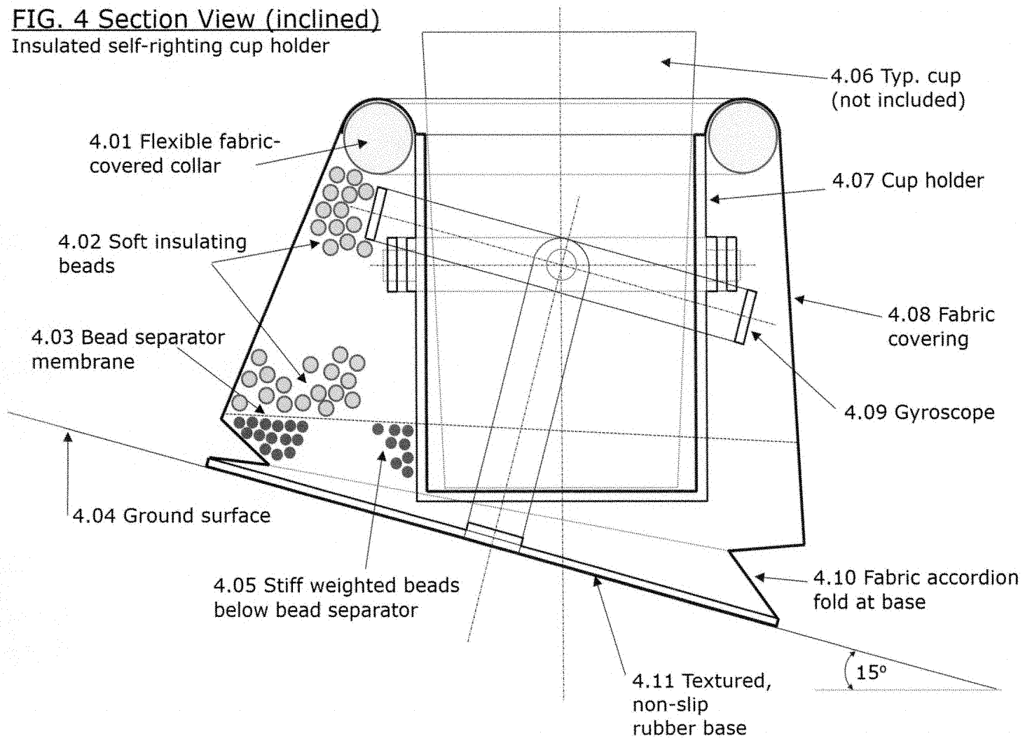

### DETAILED DESCRIPTION OF THE INVENTION

The gyroscopic cup holder (1.03) is made from several injection molded plastic parts: a) the cup holder itself which is large enough to hold a 16 ounce beverage cup, b) the middle ring of the gyroscope that is attached to the cup holder in two places (opposite each other) and is allowed to freely rotate on the axis of those two connections, c) an outside ring (2.07) that is attached to the middle ring at two locations 90 degrees offset from the locations connecting the cup holder to the middle ring. Each of these connections are also allowed to freely rotate on their axis. The gyroscopic cup holder is attached to the base using a molded plastic bracket (2.04) that has a fixed (non-rotating) attachment to the outside ring (2.07).

Attached around the top of the cup holder is a flexible, tubular collar (1.02). The fabric cover of the invention wraps over the top of the collar and is attached between the collar (1.02) and the cup holder (1.03).

A horizontal bead separator membrane (2.06) wraps around the cup holder and attaches to the inside of the fabric cover. This membrane separates the lighter weight insulating foam beads (2.01) above from the heavier weight weighted beads (2.02) below.

The invention enclosure is “stuffed” with insulating foam beads (2.01) above the membrane (2.06) and between the fabric cover (1.01) and the cup holder (1.03) inside. The invention enclosure is “stuffed” with weighted beads (2.02) below the membrane (2.06) and between the fabric cover (1.01) and the cup holder (1.03) inside. They also are stuffed below the cup holder (1.03), but not so tight as to hinder the operation of the gyroscopic cup holder (1.03).

The textured, non-slip rubber base (2.05) completes the invention enclosure and is attached to both the gyroscopic cup holder (1.03) and the edges of the fabric cover (1.01). The fabric cover (1.01) is folded like an accordion (2.03) where it is attached to the base to allow for expansion and contraction as the invention is moved from horizontal to inclined surfaces.

1. (canceled)

2. (canceled)

3. Prior art for patent 2020/0398726 (inventors are Edward Frye and Ethan Cating) hereafter referred to as “Frye/Cating” was published on Dec. 24, 2020. Application for this patent was filed on May 31, 2020, 15 days before the application was filed for this invention. Frye/Cating describes a gyroscopic cup holder designed to specifically fit into the OEM cup holder of a motorized vehicle to maintain the vertical orientation of the invention. The Frye/Cating drawings specifically reference elements designed to reduce vibration caused by the movement of the vehicle that Frye/Cating is attached to. Frye/Cating is not a free-standing invention, it does not provide insulating properties, and it is not designed to be used outside of a vehicle environment. Without the OEM vehicle cup holder support, Frye/Cating has no useful function. Unlike Frye/Cating, the invention described in this patent application does not require any external attachment or vertical support, nor should it be used inside a moving vehicle. Therefore no vibration reduction as per Frye/Cating is required. The invention is free-standing and does not require any external support or attachment in order to function as described. Also unlike Frye/Cating, insulation to maintain a beverage's preferred temperature is provided by the invention without attachment to an external cooling or heating source. The invention provides insulation to both cold and warm beverages, keeping them either cold or warm compared to ambient temperatures.
An invention described by prior art for patent U.S. Pat. No. 6,581,888B1 (inventor is Kenneth Castillo) hereafter referred to as “Castillo” was published on Jun. 24, 2003. Castillo describes a cup holder that is essentially a maleable bean bag. A beverage vessel is meant to be attached to the invention using an “elastomeric opening” in the invention's cover that presumably seals tightly enough around the beverage vessel to hold it in place. The weighted beads inside the fabric cover are meant to do two things: 1) stabilize the invention on the surface it is resting on, and 2) allow the held beverage vessel to stay upright, even on inclined surfaces. Castillo depends entirely on the beads inside the cover to adjust to an irregular or inclined surface at the bottom while the top of the beads remains level to support the beverage vessel in a vertical orientation. Castillo has no provision for beverage insulation as the beads only serve the function of stabilizing the invention. They do not provide any insulation of the beverage vessel itself as they do not surround the beverage vessel in anyway. Furthermore, it appears that once attached to the invention, it is not an easy operation to remove the beverage vessel from the invention without some effort. This effort could in fact defeat the purpose of the cup holder by spilling the contents of the beverage vessel. The only similarity between Castillo and the invention is the wide, weighted base using beads. Unlike Castillo, the invention does not rely on the user “molding” the invention to the surface it is resting on in order to keep the beverage vessel upright. The success of which is entirely dependent on the user's skill in molding the beads. The invention uses the internal gyroscopic cup holder to keep the beverage vessel upright and does not rely on the user at all. The insulating beads are loosely packed enough to move as the cup holder moves (eg. self-righting). Unlike Castillo, this invention offers insulation of the beverage vessel by surrounding the vessel with insulating beads. The weighted beads are used exclusively for stabilizing the invention and are separated from the insulating beads by a bead separator membrane. Unlike Castillo, the invention does not require that the invention “grip” the beverage vessel in any way. The beverage vessel is simply placed in the gyroscopic cup holder and can be easily removed without spilling the beverage. No elastomeric orifice gripping is required to hold the beverage vessel in place.
In summary, there are patented inventions that utilize gyroscopic cup holders (ie. Frye/Cating, U.S. Pat. No. 4,819,843) but none of them are designed to be free-standing and/or insulating. There are also patented inventions that offer free-standing cup holders (ie. Castillo, U.S. Pat. Nos. 3,312,436, 4,964,600, 7,568,362), but none of them utilize a gyroscope to keep the beverage vessel upright in combination with insulating properties. The invention is unique in providing both the self-righting capabilities of a gyroscopic cup holder AND the free-standing benefits of a bean bag cup holder along with insulating capabilities usually lacking in both existing approaches to the problem.
